(19) United States
(12) Patent Application Publication
(10) Pub. No.: US 2010/0224016 A1
(43) Pub. Date: Sep. 9, 2010

(54) Device for a Vibration Generator

(75) Inventors: Albrecht Kleibl, Grosshennersdorf (DE); Christian Heichel, Niedernberg (DE)

Correspondence Address: MILLER, MATTHIAS & HULL, ONE NORTH FRANKLIN STREET, SUITE 2350, CHICAGO, IL, 60606, US

(73) Assignee: Abi Anlagentechnik Baumaschinen-Industriebedarf Maschinefabrik Und Vertriebsgesellschaft MBH, Niedernberg (DE)

(21) Appl. No.: 12/601,492

(22) PCT Filed: May 23, 2008
(86) PCT No.: PCT/EP08/04142

§ 371 Date: Apr. 13, 2010

(30) Foreign Application Priority Data
May 23, 2007 (DE) 10 2007 023 963.9

(51) Int. Cl. B06B 1/10; E02D 7/18; F16F 1/36

(52) U.S. Cl. 74/61; 267/153

(57) ABSTRACT

A device for a vibrator, including at least one resilient element, with a force/travel curve having a first region, at least approximately given by an equation of formula K=a+b*W, where K is the spring force of the at least one resilient element, W is the spring travel and a and b are number greater than zero and a vibrator including such a device.

### FIELD OF THE INVENTION

The present invention generally relates to vibration generators and, particularly, to a device for a vibration generator for providing initial tension and/or damping in a vibration generator.

### BACKGROUND OF THE INVENTION

Vibration generators are used, for example, for driving piling material into the ground. Sometimes, such vibration generators are also referred to as vibrators. A vibration generator generates forces to be transferred to piling material by means of unbalanced weights arranged on axles. Upon rotation, the individual unbalanced weights generate forces, which mutually complement, increase each other in the direction, in which forces are transferred onto piling material (e.g. in driving direction); at least in directions oblique thereto, they cancel each other out.

In order to support and increase, respectively, forces of a vibration generator in one direction (e.g. in driving direction), it is possible to generate an initial tensioning force in that direction. In known applications where piling material is driven into ground, such initial tensioning forces are in the range of 200 kN.

Usually, such initial tensioning forces are generated by using so-called rubber-bonded metal rails. A rubber-bonded metal rail comprises two layers (e.g. steel sheets or plates) between which a resilient layer (e.g. an intermediate layer made from rubber) is arranged.

Since generally high forces occur in vibration generators, initial tension generating means are necessary, which can withstand these forces. It is further desired to design the resilient properties of such means to be soft in order to reduce an undesired transfer of oscillations and/or vibrations to other components. Furthermore, it is desired to enhance the effect of a vibration generator such that, as a result of initial tensioning, forces as large as possible are generated in the effective direction. In contrast thereto, it is disadvantageous in the case a means generating initial tension has a large travel.

In a means generating initial tension in form of a rubber-bonded metal rail, the spring characteristic can be made softer by increasing the thickness of the resilient layer intermediately located (e.g. rubber layer). This results in an increased weight, enlarged constructional space and larger travel. The latter is also disadvantageous in so far as larger travel also leads to an enlarged overall configuration of the vibration generator; further, it requires more effort to connect and attach, respectively, components used with the vibration generator (e.g. dimensions of guides; length of supply lines and/or feeds, e.g. electrical connections, hydraulic tubes, etc.).

A further aspect with respect to vibration generators is that forces generating means (e.g. rotating unbalanced weights) can also generate forces acting on portions where this is not desired and can result in damages. In a leader guided vibration generator during operation it is possible that, for example, forces being undesired and/or resulting in damages can be transferred to the leader (in German: Mäkler) and/or to components between the leader and the actual vibration generator. This correspondingly applies to forces, which upon interaction with, for example, piling material are (back) transferred to the vibration generator and are propagated therefrom.

In order to prevent such phenomena and to at least reduce their effects, respectively, damping elements are used, which dampen undesired/detrimental force transfers. Such damping elements may be, for example, provided between a vibration generator and a device or structure, by means of which the vibration generator is supported, guided, moved, etc. (e.g. a leader or an extension arm of a construction machine).

Normally, separately made damping elements are used, what can result in increased weight and larger constructional space. The above mentioned rubber-bonded metal rails can also act as damping means if accordingly installed; in such a case, problems comparable with those of vibration generation, namely soft spring characteristic, large spring travel, etc. arise.

### OBJECT OF THE INVENTION

Object of the present invention is to provide solutions, which avoid shortcomings of known measures, which are used to generate initial tension and/or for damping in vibration generators, and, particularly, to provide a device capable of being used in vibration generators for generating initial tension and/or for damping, which device is capable of absorbing relatively large forces, has a relatively soft spring characteristic for the load range and/or spring travel desired for the operation of the vibration generator and which is of low weight.

### SHORT DESCRIPTION OF THE INVENTION

For solving the above object, the present invention provides a device and a vibration generator comprising such a device according to the independent claims.

The device according to the invention is provided for use with a vibration generator and comprises at least one resilient element, which has a force-travel characteristic curve having a first range, which is at least approximately characterized by an equation in the form of K=a+b*W, wherein K is the spring force, W is the spring travel and the spring deformation, respectively, and a and b are numbers larger than zero.

For example, depending on an application and/or depending from its installation and/or operation and/or setting, the device according to the invention may generate initial tension, act as damper or both generate initial tension and act as damper. Here, the device according to the invention (particularly for illustration) can be referred to as initial tensioning and/or damping device and/or device for at least one of initial tension generation and damping.

Described in other words, plotting the force-travel characteristic curve in a coordinate system, the characteristic curve has a range, which can be described as linear at least approximately. This characteristic curve's range (or a straight line, by means of which this characteristic curve's range can be, at least approximately, described) may have a positive slope; for further embodiments the slope may be negative. At least approximately, this characteristic curve's range corresponds with a straight spring characteristic curve. (Mentally) lengthening this first characteristic curve's range in a direction towards the axes of the coordinate system (e.g., by plotting in the coordinate system the straight line, by means of which this characteristic curve's range can be, at least approximately, described), the result is a point of intersection with the y-axis at an y value (force) lager than zero; the origin of the coordinate system is not intersected.

The force-travel characteristic curve of the at least one resilient element may comprise a second, degressive range and/or a third, progressive range.

Preferably, the first characteristic curve's range is between the second characteristic curve's range and the third characteristic curve's range.

In preferred embodiments, the at least one resilient element may generate in the degressive characteristic curve's range forces smaller than in the progressive characteristic curve's range.

Then, in the coordinate system, the degressive characteristic curve's range is left from the first characteristic curve's range and the progressive characteristic curve's range is right therefrom.

In preferred embodiments, the at least one resilient element may generate in the progressive characteristic curve's range forces smaller than in the degressive characteristic curve's range. Then, in the coordinate system, the progressive characteristic curve's range is right from the first characteristic curve's range and the degressive characteristic curve's range is left therefrom.

Preferably, the at least one resilient element comprises at least one spring at least partially made from an elastomer and, particularly, a cellular elastomer. A spring including or being made of a cellular elastomer is particularly intended because this has a force-travel characteristic curve, which is degressive in the case of small spring forces and small spring travel (spring deformation), respectively, then has an almost linear range and is progressive in the case of large spring forces and large spring travel. In addition, a cellular elastomer is suitable for accommodating large forces (spring deformation), respectively.

In addition or as alternative, such a force-travel characteristic curve may be achieved by means of forming of the at least one resilient element or such forming can contribute to achieve such a force-travel characteristic curve.

In preferred embodiments, the at least one resilient element is arranged in (statically) initially tensioned manner. To this end, the at least one resilient element may be, for example, installed under pressure, partially compressed.

The device according to the invention may include at least one first unit (which may be also referred to as initial tensioning and/or damping unit), which comprises at least one resilient element and is adapted to generate an initial tensioning force in the effective direction of the vibration generator and/or dampening forces in directions parallel to the effective direction.

The first unit may comprise at least two resilient elements, preferably four elements, arranged in parallel, particularly those made from a cellular elastomer.

The device according to the invention may (also) include at least one second unit (which may be also referred to as initial tensioning and/or damping unit), which comprises at least one resilient element and is adapted to generate an initial tensioning force in the effective direction of the vibration generator and/or dampening forces in directions parallel to the effective direction.

The second unit may comprise at least two resilient elements, preferably four elements, arranged in parallel, particularly those made from a cellular elastomer.

In further preferred embodiments, the at least one resilient element may be supported between a contact portion and a holding portion.

In further preferred embodiments, at least two resilient elements may be provided, wherein at least one resilient element may be supported between a first contact portion and a first holding portion, while at least another resilient element may be supported between a second contact portion and a second holding portion.

The contact and holding portions may be arranged moveably in relation to each other in a direction parallel to the effective direction of the vibration generator. In the case of first and second contact and holding portions, the first contact and holding portions and/or the second contact and holding portions and/or the first holding portion and the second contact portion and/or the second holding portion and the second contact portion may be arranged moveably in relation to each other in a direction parallel to the effective direction.

Preferably, an actuation element is provided, which is adapted to actuate the device according to the invention to generate a initial tensioning force. Particularly, it is intended that the at least one resilient element can be compressed and/or expanded by means of the actuation element.

There, the actuation element and the first and/or the second unit may be coupled, preferably may be in engagement.

Here, it is noted that the term “coupling” and formulations comparable therewith, like “coupled”, comprise that two members are immediately, directly connected with each other, for example by means of one or several screw, clamping, adhesive, welded connections and/or form fit and/or frictional connections. However, the term “coupling” and formulations comparable therewith, like “coupled”, also comprise that two members are indirectly connected with each other, for example by a connection device arranged therebetween.

In contrast thereto, the term “connection” and formulations comparable therewith, like “connected”, indicate that two members are, as set forth above in exemplary manner, immediately, directly connected.

As alternative and/or in addition, the actuation element and the (if applicable at least one) holding portion may be coupled, preferably may be in engagement.

Particularly, it can be intended that the actuation element and the (or the first and/or the second) holding portion are connected with each other in such a manner that a resilient element arranged therebetween can be supported under initial tension.

In preferred embodiments, the device according to the invention comprises a coupling element (e.g. in form of an arm).

The coupling element may be formed in a manner to introduce forces, which initially tension the at least one resilient element.

To this end, the coupling element and the actuation element may be coupled, preferably may be in engagement.

In addition or in alternative, the device according to the invention may comprises one or more actuators, which are capable of initially tensioning the at least one resilient element. To initially tension the at least one resilient element, the at least one actuator may be activated or deactivated; this may depend, for example, from the actuator type and/or the respective coupling with the at least one resilient element. As actuators, electro-mechanical, mechatronic, hydraulic, pneumatic, piezo-electric, mechanical, . . . actuators may be used.

Further, the coupling element may be adapted to be coupled with a guiding means (for example a slide provided for arrangement on a leader) for the vibration generator or, respectively, to interact therewith.

In order to use the device according to the invention with a vibration generator, it may be advantageous that the device according to the invention comprises a support structure, which is adapted for being coupled with the vibration generator.

The support structure may be a yoke-like or yoke-formed structure.

Further, the present invention provides a vibration generator, which has an effective direction and comprises the device according to the invention according to one of the above described embodiments.

The effective direction of the vibration generator may be a driving direction or an expulsion direction.

Preferably, the vibration generator comprises at least two excitation modules; such embodiments may also be referred to as modular vibration generators.

Preferably, the vibration generator comprises one or more guiding means, by means of which the vibration generator may be guided on, for example, a leader, a guide rail, an extension arm of a construction machine or the like, moved thereon and/or positioned therewith. Particularly, it is intended that the vibration generator according to the invention may be moved in parallel to the effective direction via the guiding means.

The at least one guiding means may be coupled with the at least two excitation modules. In addition or in alternative, the at least one guiding means may be connected with, if provided, the connection device.

In preferred embodiments, the guiding means comprises at least one slide.

For transferring the initial tensioning force, the device according to the invention and the at least two excitation modules and/or the device according to the invention and the connection device and/or the device according to the invention and the guiding means may be coupled with each other.

### SHORT DESCRIPTION OF THE DRAWINGS

In the following, preferred embodiments of the present invention are described with reference to the accompanying drawings, which show:

FIG. 1 a schematic illustration of a vibration generator with two excitation modules, which comprises the present invention;

FIG. 2 a schematic cross-sectional illustration of a vibration generator with three excitation modules, which is provided for use with the present invention; and

FIG. 3 force-travel characteristic curves for an initial tensioning device according to the prior art and a device according to the invention.

### DESCRIPTION OF PREFERRED EMBODIMENTS

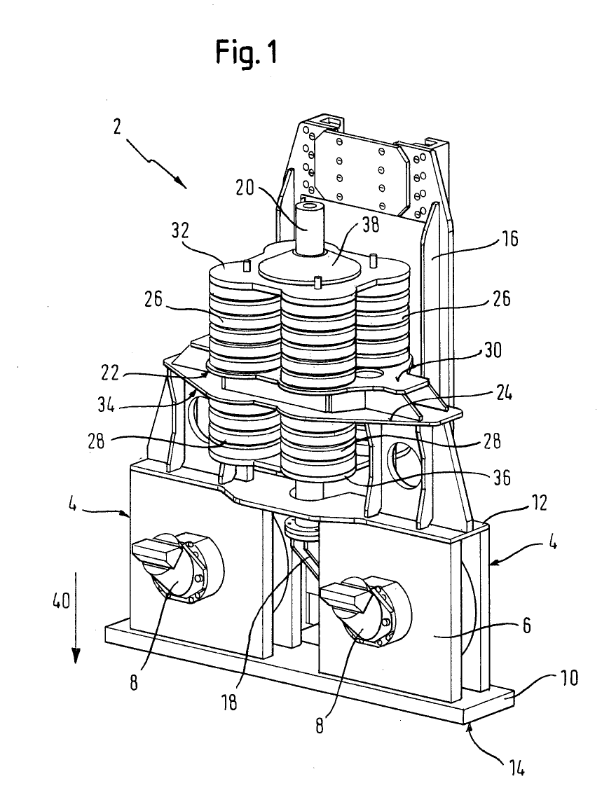

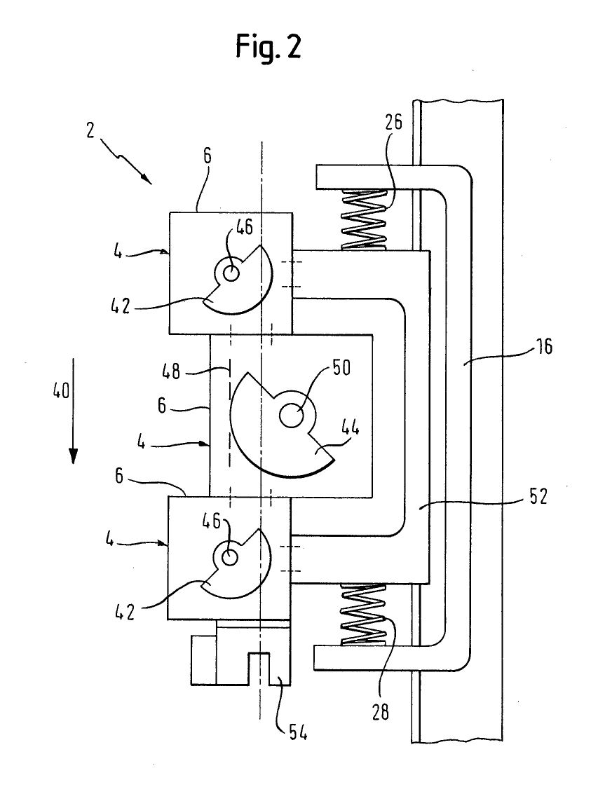

With reference to FIGS. 1 and 2, in the following preferred embodiments of vibration generators, which may be provided for use with the present invention, are described.

FIG. 1 shows an embodiment of a vibration generator, which as a whole is designated by 2. The vibration generator 2 comprises two excitation modules 4, which are, for the sake of simplicity, illustrated as being of the same type, which however can differ.

The excitation modules 4 respectively comprise an own housing 6, in which a rotatable axle (not shown) is arranged, on which one or more unbalanced weights (not shown) are mounted.

Further, the excitation modules 4 respectively comprise, on their housings 6, a rotation drive 8 for the respective axle.

The excitation modules 4 are connected with each other via a connection device. According to FIG. 1, the connection device comprises a plate-like and, respectively, sheet-like connection element 10, on which the, according to the drawing, lower sides of the housings 6 are mounted, for example by means of one or several screw, clamping, adhesive, welding connections and/or form fit and/or frictional connections.

The connection device also comprises a further connection element 12, which, as illustrated, may also be plate-like and sheet like, respectively. The connection element 12 connects, according to the drawings, the upper sides of the housings 6, for example in a manner named for the connection element 10.

The, according to the drawings, lower side of the connection element 10 is adapted to cooperate with a portion (e.g. an upper side of piling material), onto which forces generated by the vibration generator are to be transferred. To this end, the lower side of the connection element 10 may be at least partially designed as mounting portion 14. The mounting portion 14 may include, for example, reinforced portions for force transfer, threaded bores, projecting threaded pins and/or bolts for form fit and/or frictional connection and/or clamping means described with reference to FIG. 2 (e.g. clamping pliers) in order to be, for example, coupled with piling material.

The vibration generator 2 further comprises a guide means 16, which may be connected with the connection element 10, the connection element 12, one or both housings 6. The guide means 16 is indirectly coupled with the housings 6 and the connection means 10, 12, respectively, via an arm-like coupling element 18 extending from the guide means 16 between the housings 6.

The coupling takes place starting from the coupling element 18 via an element 20 being, according to the drawings, bar-like and hollow cylinder-like, respectively, which is connected with the coupling element 18. The element 20 cooperates with a initial tensioning and/or damping device 22, which in turn is connected with the connection element 12 via a support structure 24 being according to the drawings joke-like and, thus, is connected with the housings 6 and the excitation modules 4, respectively. Due to the below described effect and/or functionality of the element 20, it can be referred to as actuation element for the device 22.

The support structure 24 is connected with the, according to the drawings, upper side of the connection element 12, for example in one of the ways described above.

The device 22 comprises a first unit (initial tensioning and/or damping unit) including first resilient elements 26, which according to FIG. 1 extend vertically in the upward direction above the support structure 24. The device 22 further comprises a second unit (initial tensioning and/or damping unit) including second resilient elements 28, which according to FIG. 1 extend vertically in the downward direction below the horizontally extending portion of the support structure 24.

The first resilient elements 26 are supported between a first contact portion 30 of the support structure 24 and a first holding portion 32. The first holding portion 32 can be, for example, as illustrated in FIG. 1, formed as holding plate.

The first contact portion 30 and the first holding portion 32 are moveable in relation to each other. Movements of the first holding portion 32 towards the first contact portion 30 (here, the holding plate 32 is moved in the direction of arrow 40) load (compress) the first resilient elements 26. Movements of the first holding portion 32 away from the first contact portion 30 (here, the holding plate 32 is moved in a direction opposite to the direction of arrow 40) release the first resilient elements 26.

The second resilient elements 28 are supported between a second contact portion 34 and a second holding portion 36. The second holding portion 36 can be, for example, as illustrated in FIG. 1, formed as holding plate.

The second contact portion 34 and the second holding portion 36 are moveable in relation to each other. Movements of the second holding portion 36 towards the second contact portion 34 (here, the holding plate 36 is moved in a direction opposite to the direction of arrow 40) load (compress) the second resilient elements 28. Movements of the second holding portion 36 away from the second contact portion 34 (here, the holding plate 36 is moved in the direction of arrow 40) release the second resilient elements 26.

The first and second resilient elements 26 and 28 may comprise, for example, spirally formed springs or cellular elastomer.

The element 20 being coupled with the guide means 16 via the coupling element 18 is connected with the first and second, respectively, holding portions 32 and 36 by means of a first cap 38 and a second cap (not shown) being formed comparable with the first cap 38.

The guide means 16 is, for example, formed as slide or formed in slide-like manner at its, according to the drawings, rear side and is provided for guiding and, particularly, for positioning and for moving the vibration generator 2 on a support, which is, for example, provided by a leader or an extension arm of a construction machine.

Here, it is assumed that the direction of the arrow 40 is an effective direction or driving direction, in which, for example, piling material is to be driven (piled) into ground. In not shown embodiments, an effective direction being opposite to the direction of the arrow 40 may be provided, which can be referred to as expulsion direction, in which, for example, piling material being located in the ground can be withdrawn from the ground.

By means of the device 22 initial tensioning forces may be generated in both the effective direction 40 and in a direction opposite thereto. In the shown embodiments, the resilient elements 26 act to generate an initial tensioning direction in the effective direction 40, while the resilient elements 28 act to generate an initial tensioning direction opposite to the effective direction 40.

In order to generate an initial tensioning force in the effective direction by means of the resilient elements 26, the guide means 16 may be moved in relation to the support structure 24 and components connected therewith, according to the drawings, downward. Along therewith, also the element 20 as well as the first cap 38 connected therewith and the first holding portion 32 are moved downward. This compresses the first resilient elements 26, which then generate an initial tensioning force in the effective direction 40. This initial tensioning force may be used to enhance forces altogether generated by the excitation modules 4, resulting and acting in the effective direction 40. Such initial tensioning forces may particularly be beneficial in the case piling material is to be introduced into ground by means of the vibration generator.

In order to generate an initial tensioning force opposite to the effective direction by means of the resilient elements 28, the guide means 16 may be moved in relation to the support structure 24 and components connected therewith, according to the drawings, upward. Along therewith, also the element 20 as well as the second cap connected therewith and the second holding portion 36 are moved upward. This compresses the second resilient elements 28, which then generate an initial tensioning force in a direction opposite to the effective direction 40. This initial tensioning force may be used to enhance forces altogether provided by the excitation modules 4 and acting in a direction opposite to the effective direction 40. Such initial tensioning forces may particularly beneficial in the case piling material is to be removed from ground by means of the vibration generator.

Initial tensioning forces by means of the first resilient elements 26 can also be generated by providing a means, by which the first resilient elements 26 can be compressed. Such a means may comprise, for example, one or more hydraulic, pneumatic, piezo-electric and spring forces providing actuators, by which, for example, the first holding portion 32 and/or the first cap 38 may be moved in a direction towards the first contact portion 30. One or more actuators may be arranged, for example, between the first resilient elements 26 and/or integrally formed with the element 20.

Initial tensioning forces by means of the second resilient elements 28 can also be generated in comparable manner.

Furthermore, the device 22 provides damping of forces, which can be transferred between the guide means 16 and the support structure 24 and components connected therewith, respectively. Here, it is not necessary to actuate the device 22 as described with respect to the generation of initial tension. Rather, the device 22 provides for damping in the effective direction and/or in an opposite direction.

For example, if forces act, starting from the support structure 24, in a direction opposite to the effective direction 40 (in FIG. 1 upward) and onto the device 22, the first resilient elements 22 are compressed, whereby—as far as forces are actually transferred to the guide means 16—these forces are dampened. Along therewith, a lengthening of the second resilient elements 28 may occur, for example, if they are connected with the second contact portion 34 and the second holding portion 36. In that way, an additional damping can be achieved. These observations correspondingly apply to forces acting on the device 22 in the effective direction.

For example, depending from the design and/or material properties of the first and/or second resilient elements 26 and 28, it may advantageous to install the first and/or second resilient elements 26 and 28 in initially tensioned manner. Thus it can be achieved that the damping characteristics in and opposite to the effective direction 40 may be set and varied in the same way or differently. Particularly, an initially tensioned installation can result in a situation that the first and/or second resilient elements 26 and 28 respectively operate in a desired range of their force-travel characteristic curves.

The observations made above with reference to FIG. 1 apply to FIG. 2—apart from the explained differences—correspondingly. Therefore, a repetition is refrained from.

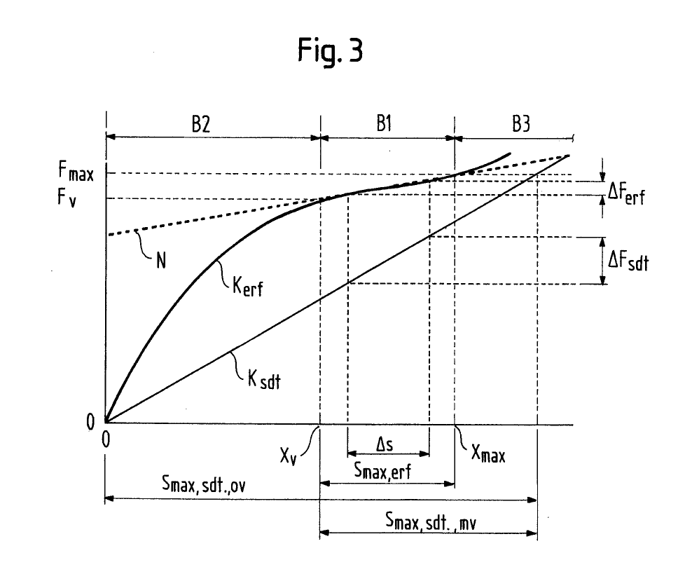

In the embodiment illustrated in FIG. 3, three single-axel excitation modules 4 are provided.

The excitation modules 4 of FIG. 2 comprise an, according to the drawings, upper and a, according to the drawings, lower excitation module 4 and an excitation module 4 arranged therebetween. The upper and lower excitations modules 4 together have the same static moment as the intermediately arranged excitation module 4; in FIG. 2 this is illustrated by the unbalanced weights 42 and 44, respectively, being correspondingly shown to have different sizes.

The upper and lower excitation modules 4 are arranged such that their axles 46 extend in parallel to each other in a plane 48, which extends parallel to the effective direction 40. The axle 50 of the middle excitation module 4 is also arranged in parallel with the axles 46, but does not lie in the plane 48.

The upper and lower excitation modules 4 are, via their housings 6, connected to the, according to the drawings, upper and lower, respectively, sides of the housing 6 of the middle excitation module 4. Further, there is provided a connection device, which comprises an arm or support 52 having a U or C shaped cross-section. Connections of the excitation modules with each other and/or the arm and support 52, respectively, may be realized in the ways mentioned above.

On the, according to the drawings, lower side of the lower excitation module 4, a connection portion 14 is provided, on which in turn a means 54 is arranged, which may be coupled with a portion (e.g. upper side of piling material) onto which resulting forces of the vibration generator are to be transferred. For example, the holding means 54 may comprise one or more clamping pliers in order to hold, for example, piling material. Alternatively and/or in addition, for example, piling material may be directly connected to the mounting portion 14.

The arm 52 is connected with a guide means 16 via one or several first resilient elements 26 and via one or several second resilient elements 28. The resilient elements 26 and 28 represent components of a device according to the invention having first and second units, which comprise the resilient elements 26 and 28, respectively.

The guide means 16 may be formed, for example, as slide, which is capable of cooperating with a respective portion of a leader.

In the following, properties, effect and function of the device 22 are described in greater detail.

The device 22 according to the invention comprises resilient elements 26 and 28, which, according to the drawings, respectively comprise four springs made of cellular elastomer. As illustrated in FIG. 1, disc-like or tablet-like spring elements may be arranged on top of each other for forming the individual springs.

The springs (together or at least partially individually considered) have a force-travel characteristic curve K_{erf}, which, as illustrated in FIG. 3, is degressive in the case of small forces or small spring travel, respectively, then has a range, which is almost linear or may be considered as linear, and is progressive in the case of large forces or large spring travel, respectively.

Such a force-travel characteristic curve may be obtained in that the springs consist, for example, of cellular elastomer or comprise the same to an extent that the resulting force-travel characteristic curve is of the kind shown in FIG. 3. In the latter case, for example, it is possible to use springs comprising resilient components/materials having a linear force-travel characteristic curve and such having a linear force-travel characteristic curve of the type of FIG. 3. This can be achieved, for example, by a combination of spiral springs and elastomer springs.

The approximately linearly extending characteristic curve's range represents a soft spring characteristic, however extends, if being mentally lengthened towards the axes of the coordinate system in FIG. 3, not through the origin of the coordinate system. This is indicated by the dotted line/straight line N in FIG. 3.

In FIG. 3, the almost linear characteristic curve's range is indicated by B1, the degressive range is indicated by B2 and the progressive range is indicated by B3.

For comparison, in FIG. 3 a force-travel characteristic curve K_{sdt} for a spring member common in the prior art for generation of initial tensioning forces (e.g. rubber-bonded metal rail) is shown.

It may be advantageous to install the resilient elements 26 and resilient elements 28 between the contact and holding portions 30 and 32, and 34 and 36, respectively, in static initially tensioned manner. That way, for example, in applications, where forces (e.g. from the excitations modules 4 and/or the guide means 16) are transferred to the device, the deformation of which under load can be limited. However, it is also intended to use the device according to the invention in not static initially tensioned manner.

Particularly, it is intended to install the resilient elements 26 and resilient elements 28 in static initially tensioned or, respectively, deformed manner such that, due to the initially tensioned installation, (respectively) resulting forces result, which are at the left of the beginning of the almost linear range B1 in FIG. 3. A further deformation (compression) then results in spring forces and spring travel, respectively, according to the almost linear range B1.

According to FIG. 3, it is assumed that, with a view on an initially tensioned installation, a spring deformation of a spring travel of xᵥ is effected by applying an installation-determined static initial tensioning force.

Starting from, as illustrated in FIG. 3, a maximum (e.g. maximally allowed and/or desired) spring load of Fₘₐₓ, the result is a maximum spring travel S_{max,erf} according to the characteristic curve K_{erf}. In contrast thereto, according to the characteristic curve K_{sdt} according to the prior art, in the case without initial tension a maximum spring travel of S_{max,sdt,ov} results and in the case with static initial tension and the same spring deformation xᵥ a maximum spring travel of S_{max,sdt,mv} results, both of which being (significantly) larger than the spring travel S_{max,erf}.

A further advantage of the device 22 according to the invention is that vibrations and oscillations, respectively, generated by the vibration generator 2 lead to, as compared with the prior art, smaller forces, which are, for example, transferred to the guide means 16 and therefrom to, for example, a leader. Assuming, for example, as illustrated in FIG. 3, that vibrations and/or oscillations of the vibration generator 2 cause that a spring has a spring travel of Δs, according to the characteristic curve K_{erf} the result is a force difference of ΔF_{erf}, which is or can be transmitted from the device 22. In contrast thereto, for the characteristic curve K_{sdt} and the same spring travel of Δs the result is a force difference of ΔF_{sdt}, which is larger than the force difference ΔF_{erf}. In the result, by means of the device 22 according to the invention, inter alia,—as compared with the prior art—a softer spring characteristic with smaller spring travel and vice versa is achieved.

The maximum spring force Fₘₐₓ indicates the maximum spring force and maximum spring travel xₘₐₓ, respectively, at which the device 22 operates in the (almost) linear characteristic curve's range B1. However, also higher force and larger spring travel can be realized by means of the device 22; then, the device 22 operates in the progressive characteristic curve's range B3. This can be the case, for example, if the device 22 receives from the guide means 16 a force being larger than Fₘₐₓ; this can occur also in the case the device 22 receives resulting forces from the excitation modules 4 being larger than Fₘₐₓ.

In such cases, the device 22 still has resilient properties, which however follow the characteristic curve's range B3 now. Accordingly, the result is a—as compared with the characteristic curve's range B1—progressive stiff spring characteristic having associated a shorter spring travel and vice versa, respectively.

This has the benefit that also in the case of forces being larger than Fₘₐₓ and spring travel being larger than xₘₐₓ, respectively, resilience is still provided; in contrast thereto, in the prior art comparable conditions would generally result in that—particularly in order to avoid damages of the springs—one or more mechanical stops would be reached, whereby resilient properties are (can be) provided not longer, but a stiff system results. The latter is also true for cases where springs according to the prior art end up at the “end” of their characteristic curve and are maximally compressed, respectively; a situation, which cannot or nearly cannot occur with the device according to the invention (due to the progressive characteristic curve's range).

A further benefit is that for operation in the characteristic curve's range B3 vibrations and/or oscillations generated by the excitation modules are transferred to the guide means and the leader, respectively, in lesser damped manner by the device according to the invention. This can be detected and sensed, respectively, by means of sensors and/or operating staff; whereupon, the operation of the vibration generator can selected such that the characteristic curve's range B3 is left.

1-28. (canceled)

29. A damping and initial tensioning device for a vibration generator comprising
at least one resilient element comprising cellular elastomer, the at least one resilient element having a force-travel characteristic curve with a degressive range, an approximately linear range and a progressive range, and
a force-travel characteristic curve essentially determined by the at least one resilient element, which force-travel characteristic curve having a first, linear range, a second, degressive range and a third, progressive range,
wherein the first range of the force-travel characteristic curve is at least approximately indicated by an equation in the form of
K=a+b*W
wherein K is the spring force, W is the spring travel and the spring deformation, respectively, and a and b a number larger than zero.

30. The device according to claim 1, wherein the at least one resilient element is initially tensioned.

31. The device according to claim 2, wherein the at least one resilient element is initially tensioned in static manner by means of an installation-determined static initial tensioning force, which according to the force-travel characteristic curve for the device lies at the beginning of the first linear range.

32. The device according claim 1, wherein the at least one resilient element respectively comprises at least one spring at least partially made from cellular elastomer.

33. The device according to claim 1, wherein the first characteristic curve's range is between the second and the third characteristic curve's range.

34. The device according to claim 1, wherein the at least one resilient element is capable of generating forces in the second, degressive characteristic curve's range being smaller than forces in the third, progressive characteristic curve's range.

35. The device according to claim 1, comprising at least one first unit, which comprises the at least one resilient element and is adapted to generate an initial tensioning force in the effective direction of the vibration generator and/or to dampen in a direction parallel to the effective direction.

36. The device according to claim 7, wherein the first unit comprises at least two resilient elements arranged in parallel.

37. The device according to claim 1, comprising at least one second unit, which comprises the at least one resilient element and is adapted to generate an initial tensioning force in the effective direction of the vibration generator and/or to dampen in a direction parallel to the effective direction.

38. The device according to claim 9, wherein the second unit comprises at least two resilient elements arranged in parallel.

39. The device according to claim 1, wherein the at least one resilient element is supported between a contact portion and a support portion, wherein the contact portion and the support portion are arranged to be moveable in relation to each other in a direction parallel to the effective direction of the vibration generator.

40. The device according to claim 1, comprising an actuation element being adapted to actuate the device for generating an initial tensioning force.

41. The device according to claim 12, wherein the actuation element and at least one of the at least one initial tensioning unit are coupled.

42. The device according to claim 13, wherein the actuation element and the support portion are coupled with each other such that a resilient element being supported there between is supported in initially tensioned manner.

43. The device according to claim 1, comprising a coupling element, being adapted to introduce forces for actuation of the device and being coupled with the actuation element.

44. The device according to claim 15, wherein the coupling element is adapted to be coupled with a guide means for the vibration generator.

45. The device according to claim 1, comprising a support structure for coupling with the vibration generator, the support structure being a yoke-like and/or joke-formed structure.

46. A vibration generator having an effective direction and comprising the device according to claim 1.

47. A vibration generator according to claim 18, wherein the effective direction is a driving direction or an expulsion direction.

48. A vibration generator according to claim 18, comprising at least two excitation modules, wherein the device according to claim 1 and the at least two excitation modules are coupled with each other.
